(19) United States
(12) Patent Application Publication
(10) Pub. No.: US 2015/0330586 A1
(43) Pub. Date: Nov. 19, 2015

(54) BUILT-IN LIGHTING DEVICE AND CORRESPONDING PRODUCTION METHOD

(71) Applicant: Gianluigi DAL MAS, Godega Di Sant'urbano (IT)

(72) Inventor: Gianluigi DAL MAS, Godega Di Sant'urbano (IT)

(21) Appl. No.: 14/654,504

(22) PCT Filed: Dec. 23, 2013
(86) PCT No.: PCT/IB2013/061291

§ 371 Date: Jun. 19, 2015

(30) Foreign Application Priority Data
Dec. 21, 2012 (IT) TV2012A000242

(51) Int. Cl. F21S 8/02; F21V 15/01

(52) U.S. Cl. CPC F21S 8/024; F21V 15/01; F21Y 2103/003

(57) ABSTRACT

A built-in lighting device comprising a supporting body which is structured/shaped so as to be recessed in a wall with a front face which surfaces/emerges from the wall, and a light source which is placed inside a concave recess purposely realized on the front face of said supporting body; the supporting body comprising a solid compact block which is made of polymeric-material foam and downward approximates the shape of the supporting body, and a protective surface shell which is made of hard rigid composite material and covers at least the surface portion of the block of polymeric-material foam which forms/delimits the concave recess of the supporting body.

### TECHNICAL FIELD

The present invention relates to a built-in lighting device and corresponding production method.

More in detail, the present invention relates to a built-in lighting device structured to be recessed into indoor plasterboard partition walls, use to which the following description will make explicit reference without this implying any loose of generality.

### BACKGROUND ART

As known, the built-in lights which are currently recessed into the plasterboard walls basically consist of a substantially plate-shaped, solid and compact block of gypsum, which is structured/shaped so as to be recessed into the plasterboard wall with one face surfacing/emerging from the wall; and by a light source, namely a neon tube or a series of light emitting diodes, arranged on the bottom of a large, substantially pocket-shaped concave recess, which is realized on the “in sight” face of the gypsum block, i.e. on the face of the gypsum block which is intended to surface/emerge from the plasterboard wall surface, and is shaped so as to hide the light source allowing the light to come out of the mouth of the recess in all cases.

Unfortunately, gypsum is a relatively fragile compact material, and therefore this type of built-in lights must be handled with particular care, taking measures to prevent the block of gypsum from receiving shocks of any kind to avoid the immediate shattering of the part. Requirement that implies high packaging and transport costs and a long installation times with the consequent costs.

Additionally, this type of built-in light is relatively heavy with the consequent problems of storage and transport.

Disclosure of Invention

Aim of the present invention is to realize a built-in light which is simpler to handle and install and which is at the same time more cost-effective and simpler to produce.

In compliance with these aims, according to the present invention there is provided a built-in lighting device as specified in claim 1 and preferably, though not necessarily in any one of the dependent claims.

Furthermore, according to the present invention, there is provided a method for producing a built-in lighting device as specified in claim 14 and preferably, though not necessarily, in any one of the dependent claims.

### BRIEF DESCRIPTION OF THE DRAWINGS

The present invention will now be described with reference to the accompanying drawings which illustrate a non-limitative example of embodiment, in which:

FIG. 1 is a perspective and schematic view of a built-in lighting device for plasterboard walls realized according to the teachings of the present invention; whereas

FIG. 2 is a section view of the lighting device shown in FIG. 1.

### BEST MODE FOR CARRYING OUT THE INVENTION

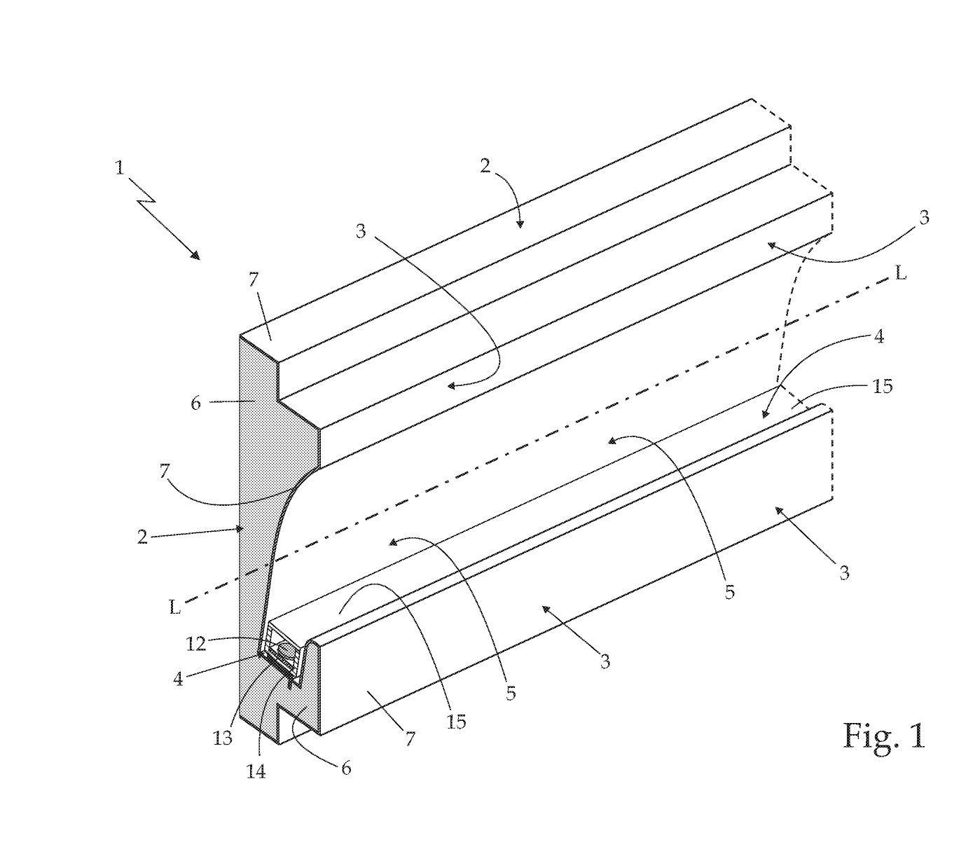

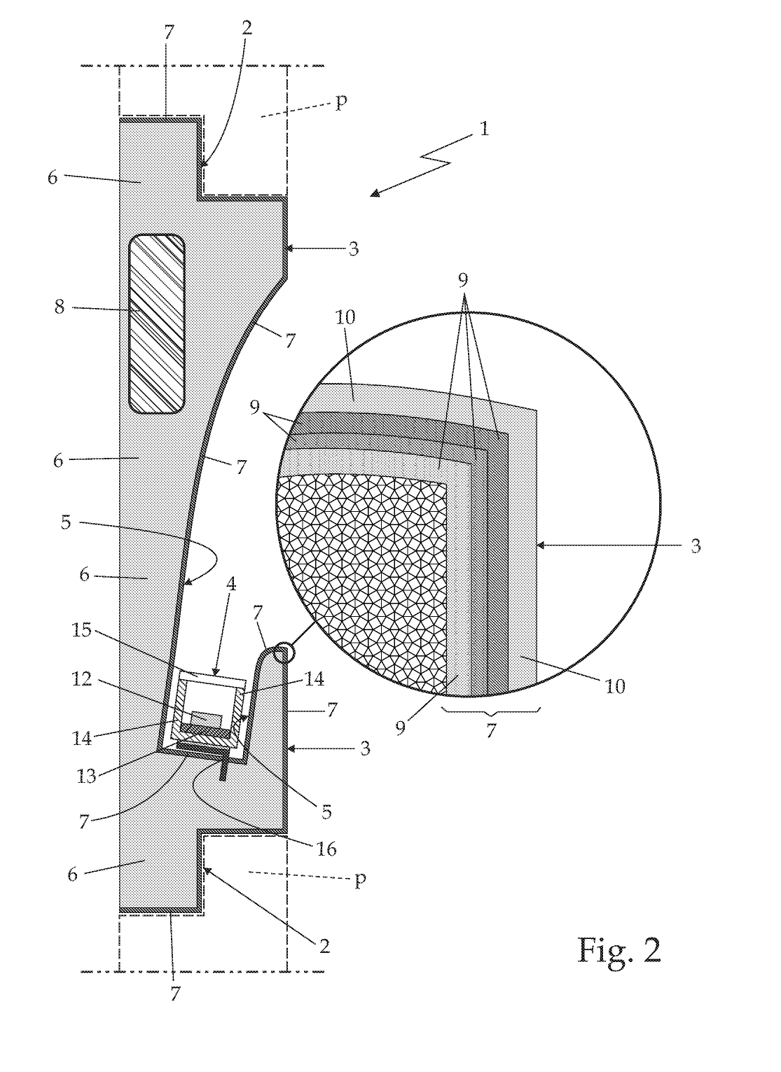

With reference to FIGS. 1 and 2, number 1 indicates as a whole a built-in lighting device which is particularly suitable to be recessed into a indoor plasterboard partition wall or the like. The built-in lighting device 1 basically comprises a substantially plate-shaped supporting body 2 which is structured/shaped to be recessed within a plasterboard wall p or the like, with one of the faces “in sight”, i.e. with the front face 3 of the supporting body 2 surfacing/emerging from the surface of the wall p; and a light source 4 which is preferably structured so as to emit light when electricity powered, and is arranged substantially on the bottom of a large concave recess 5 which is purposely realized on the “in sight” face 3 of the supporting body 2, and is preferably shaped/sized to hide the light source 4 allowing in all cases the light generated by the light source 4 to come out of the mouth of the concave recess 5.

In turn, the supporting body 2 consists of a solid and compact block of polymeric-material foam 6 which substantially downward approximates the shape of the supporting body 2, and of a protective surface shell 7 made of a hard, rigid and preferably also fireproof and/or heat-resistant composite material, which has a nominal thickness preferably less than 3 mm (millimeters), and covers at least the surface portion of the block of polymeric-material foam 6 forming/delimiting the large concave recess 5 of the supporting body 2.

More in detail, the block of polymeric-material foam 6 is preferably made of a polymeric-material foam having a nominal density greater than 15 kg/m3 (kilograms per cubic meter); the protective surface shell 7 made of hard, rigid, and preferably also fireproof and/or heat-resistant material, has a nominal thickness preferably less than 1 mm (millimeter), and extends preferably seamlessly along the entire surface of the block of polymeric-material foam 6, which forms the “in sight” face 3 of the supporting body 2.

With reference to FIGS. 1 and 2, in the example shown, in particular, the concave recess 5 on the “in sight” face 3 of supporting body 2 is preferably substantially pocket-shaped, and is preferably sized so as to hide the light source 4 allowing the light to come out of the mouth of the front recess 5 freely in all cases.

Furthermore, in the example shown the block of polymeric-material foam 6 is preferably realized of sintered polystyrene foam or other similar thermoplastic aromatic polymeric foam, with a nominal density preferably ranging between 40 and 50 kg/m3 (kilograms per cubic meter).

More in detail, with reference to FIGS. 1 and 2, in the example shown, the supporting body 2 preferably, though not necessarily, has the shape of a substantially rectilinear, plate-shaped section bar 2 which is shaped/structured so as to be recessed in a plasterboard wall p or the like with one of the large faces thereof “in sight”, i.e. with a large face 3 surfacing/emerging from the surface of the wall p.

Furthermore, the section bar 2 is provided, on the “in sight” large face, with a longitudinal, preferably pocket-shaped rectilinear groove 5, which extends substantially parallel to the longitudinal axis L of the section bar 2, preferably though not necessarily for the entire length of the section bar 2, and is finally preferably shaped/sized so as to hide the light source 4 allowing the light generated by the light source 4 to come out of the mouth of the concave recess 5 itself freely in all cases.

Preferably, with reference to FIG. 2, the supporting body 2 is further provided with a stiffening insert 8 which extends inside the block of polymeric-material foam 6.

More in detail, in the example shown the supporting body 2 shaped as section bar 2 preferably also comprises a lath of wood 8 which extends inside the block of polymeric-material foam 6 parallel to the longitudinal axis L of the section bar 2, and is preferably completely embedded in the block of polymeric-material foam 6.

Obviously, the wood lath 8 may be replaced by a longitudinal member made of plastic, composite material, aluminum or other metallic material.

With reference to FIGS. 1 and 2, the protective surface shell 7 on the other hand preferably seamlessly covers the entire surface of the block of polymeric-material foam 6 which forms the “in sight” face 3 of the supporting body 2, and in all cases at least the portion of the surface of the block of polymeric-material foam 6 intended to form the concave recess 5, and is preferably composed/made up of:
at least one intermediate layer 9 based on mineral stone powders and/or grit embedded in a resin matrix preferably of the epoxy type, which covers the surface of the block of polymeric-material foam 6; and
an outer layer 10 based on powders of gypsum and/or plaster and/or cement and/or other covering construction material embedded in a resin matrix preferably of the epoxy type, which covers the intermediate layer 9 of powders and/or grit of quartz or other stone mineral embedded in a resin matrix.

In the example shown, in particular, the protective shell 7 is preferably composed/made up of a series of intermediate layers 9 superimposed to one another (three layers in the example shown), each of which comprises powders and/or grit of quartz or other stone material with granulometry preferably ranging between 0.1 and 0.3 mm (millimeters), embedded in a resin matrix preferably of the epoxy type; whereas the outer layer 10 covers the last intermediate layer 9.

Preferably, though not necessarily, the outer layer 10 and the one or more intermediate layers 9 are further applied by spraying on surface of the block of polymeric-material foam 6.

With reference to FIGS. 1 and 2, the light source 4 preferably consists of a series of light emitting diodes 12, traditionally called LEDs, which are arranged on the upper face of a supporting and powering board 13, which is, in turn, structured/sized to be fixed onto the bottom of the concave recess 5 of the supporting body 2 with the diodes 12 facing upwards.

More in detail, in the example shown, the board 13 is substantially ribbon-shaped and is preferably housed in a rectilinear, base-holder section bar 14 with a substantially U-shaped cross section, which is preferably made of metallic material, has a length substantially equal to the length of the longitudinal rectilinear groove 5, and is finally structured/sized to be fixed onto the bottom of the longitudinal rectilinear groove. 5 made on the “in sight” face 3 of supporting body 2.

Preferably, the diodes 12 are instead arranged in substantially uniform manner on the upper face of the ribbon-shaped board 13, preferably substantially for the whole length of board 13.

The light source 4 additionally further comprises a substantially plate-shaped, diffuser cover 15 which is made of transparent or semi-transparent material, is arranged to close the mouth of the rectilinear section 14 so as to be backlighted by the diodes 12 located on the bottom of the base-holder section bar 14, and is finally structured/sized so as to diffuse the light outside, the rectilinear section 14 in substantially uniform manner.

With reference to FIG. 2, in the example shown, in particular, the light source 4 preferably comprises a series of supporting brackets 16 which are adapted to be driven into the supporting body 2 shaped as a section-bar, at the bottom of the longitudinal rectilinear groove 5, and the base-holder section bar 14 is fixed to the supporting brackets 16 in snap-fit manner, or by means of two-sided adhesive tape or permanent magnets.

Production of the lighting device 1 basically involves making a block of solid and compact polymeric-material foam 6, the shape of which downward approximates that of the supporting body 2; and then realizing, preferably on the whole surface of the block of polymeric-material foam 6 intended to form the “in sight” face 3 of supporting body 2 or, in all cases, at least on the surface portion of the block of polymeric-material foam 6 intended to form the concave recess 5, a protective surface shell 7 made of hard, rigid, and preferably also fireproof and/or heat-resistant composite material with a predetermined thickness preferably smaller than 3 mm (millimeters).

In the example shown, in particular, the production method of lighting device 1 involves to obtain the solid, compact block of polymeric-material foam 6 of the required shape, from a preferably substantially parallelepiped-shaped, large solid, compact block of polymeric-material foam, by carving/cutting in appropriate manner the aforesaid large solid, compact block of polymeric-material foam to obtain a piece of the required shape with the help of a hot wire pantograph or similar machine.

Alternatively, production of the solid, compact block of polymeric-material foam 6 comprises the step of injecting a given amount of polymeric-material foam in a mold which reproduces in negative the shape of the block of polymeric-material foam 6 to be realized, and then the step of extracting from the mold the block of polymeric-material foam 6 resulting from solidification of the polymeric-material foam inside the mold.

Preferably, production of protective surface shell 7 on surface of the block of polymeric-material foam 6 instead comprises the steps of:
covering the entire block of polymeric-material foam 6 intended to form the “in sight” face 3 of supporting body 2, or in all cases at least the surface portion of the block of polymeric-material foam 6 intended to form the concave recess 5, with at least one intermediate layer 9 of mineral stone powders and/or grit embedded in a resin matrix; and then
covering the intermediate layer 9 of powders and/or grit of quartz or other mineral stone embedded in a resin matrix with an outer layer 10 of gypsum powders and/or plaster and/or cement and/or other covering building material embodied in a resin matrix.

In the example shown, in particular, the production method of lighting device 1 preferably involves to cover the surface of the block of polymeric-material foam 6 with a plurality of intermediate layers 9 superimposed on to each other, before applying the outer layer 10 based on powders of gypsum and/or plaster and/or cement and/or other covering construction material embedded in a resin matrix.

More in detail, in the example shown, realization of each intermediate layer 9 based on mineral stone powders and/or grit embedded in a resin matrix, preferably involves to spray-spread at least one layer of resin on surface of the block of polymeric-material foam 6; and then covering such a resin layer with mineral stone powders and/or grit so that the mineral stone powders and/or grit are incorporated in the resin layer during solidification.

The resin applied by spraying is preferably an epoxy resin, while the mineral stone powders and/or grit are preferably quartz powders and/or grit with granulometry preferably ranging between 0.1 and 0.3 mm (millimeters).

When solidification of the one or more intermediate layers 9 based on mineral stone powders and/or grit embedded in a resin matrix is completed, realization of protective surface shell 7 preferably involves to spray-spread, on the last intermediate layer 9 based on mineral stone powders and/or grit embodied in a resin matrix, a liquid solution of resin and gypsum and/or plaster and/or cement and/or other covering building material, which, once solidified, forms the outer layer based on powders of gypsum and/or plaster and/or cement and/or other covering building material embedded in a resin matrix. The resin used in the liquid solution is preferably an epoxy resin.

After solidification of protective surface shell 7 on the block of polymeric-material foam 6 and the consequent realization of supporting body 2, the production method of lighting device 1 involves to place the light source 4 inside the concave recess 5 on the “in sight” face 3 of supporting body 2, preferably by arranging the light source 4 substantially on the bottom of the concave recess 5.

In the example shown, in particular, the concave recess 5 is preferably substantially pocket-shaped and the light source 4 is preferably fixed in rigid and unmovable manner onto the bottom of concave recess 5.

Operation of the built-in lighting device 1 is easily inferable from the above and therefore does not requires further explanations.

The particular structure of lighting device 1 provides many advantages. Firstly, being made nearly integrally of polymeric-material foam, supporting body 2 is particularly light and shock-resistant, and therefore may be installed very easily without particular measures.

Furthermore, specific weight (i.e. weight per unit of volume) of the polymeric-material foam is much lower than that of gypsum, therefore the lighting device 1, all sizes being equal, is much lighter than the traditional built-in lights made of gypsum with all the advantages that this implies. Last, but not least importantly, the production times and costs of lighting device 1 are lower than those of the traditional built-in lights made of gypsum.

It is finally apparent that changes and variants may be applied to the built-in lighting device 1 and the corresponding production method without, however, departing from the scope of the present invention.

For example, in a different embodiment of lighting device 1, the protective surface shell 7 may also comprise a bundle of synthetic fibers, suitably woven to one another and embedded in a resin matrix preferably of the epoxy type. Preferably, such a bundle of synthetic fibers may comprise, for example, carbon fibers and/or glass fibers and/or aramid fibers, such as Kevlar.

In this embodiment, the first intermediate layer 9 based on mineral stone powders and/or grit embedded in a resin matrix, preferably of the epoxy type, may be realized over the synthetic fiber bundle embedded in the resin matrix.

Moreover, in a second embodiment of lighting device 1, the light source 4 may be free from the rectilinear base-holder section bar 14. In this case, the board 13 may be fixed directly onto the surface of the supporting body 2, or rather onto the surface of the protective surface shell 7, by means of a two-sided adhesive tape or glue.

Finally, in a third embodiment of lighting device 1, the light source 4 may consist of a traditional neon tube suitably sized to be housed within the concave recess 5 of supporting body 2.

1. Built-in lighting device comprising a supporting body which is structured/shaped so as to be recessed into a wall with a front face emerging/surfacing from the wall, and a light source which is placed inside a concave recess purposely realized on the front face of said supporting body;
the lighting device wherein the supporting body comprises a solid compact block which is made of a polymeric-material foam and downward approximates the shape of the supporting body, and a protective surface shell which is made of hard rigid composite material and covers at least the surface portion of the block of polymeric-material foam forming/delimiting the concave recess of the supporting body.

2. Lighting device as claimed in claim 1, wherein the protective surface shell substantially covers the entire surface of the block of polymeric-material foam that forms the front face of the supporting body.

3. Lighting device as claimed in claim 1, wherein the protective surface shell has a thickness of less than 3 millimeters.

4. Lighting device as claimed in claim 1, wherein the protective surface shell is made of fireproof and/or heat-resistant material.

5. Lighting device as claimed in claim 1, wherein the protective surface shell comprises at least one layer based on mineral stone powders and/or grit embedded in a resin matrix.

6. Lighting device as claimed in claim 5, wherein the mineral stone powders and/or grit have a granulometry ranging between 0.1 and 0.3 millimeters.

7. Lighting device as claimed in claim 5, wherein the mineral stone powders and/or grit comprise powders and/or grit of quartz.

8. Lighting device as claimed in claim 1, wherein the protective surface shell comprises an outer layer based on powders of gypsum and/or plaster and/or cement and/or other covering construction material embedded in a resin matrix.

9. Lighting device as claimed in claim 1, wherein the block of polymeric-material foam is made of a polymeric-material foam having a density higher than 15 kg/m3 (kilograms per cubic meter).

10. Lighting device as claimed in claim 1, wherein the block of polymeric-material foam is made of sintered polystyrene foam or other thermoplastic aromatic polymer foam.

11. Lighting device as claimed in claim 1, wherein the concave recess on the front face of the supporting body is shaped/sized so as to hide the light source while allowing the light generated by the light source to come out through the mouth of the concave recess.

12. Lighting device as claimed in claim 1, wherein the concave recess on the front face of the supporting body is shaped substantially in the form of a pocket.

13. Lighting device as claimed in claim 1, wherein the light source comprises a series of light emitting diodes or a neon tube.

14. Production method of a built-in lighting device which comprises a supporting body structured/shaped so as to be recessed into a wall with the front face emerging/surfacing from the wall, and a light source which is placed inside a concave recess purposely provided on the front face of said supporting body
the production method comprising an operation of providing a solid compact block of polymeric-material foam whose shape downward approximates that of the supporting body; and an operation of realizing a protective surface shell made of hard rigid composite material, at least on the surface portion of the polymeric-material foam block designed to form said concave recess.

15. Production method as claimed in claim 14, wherein production of the solid compact block of polymeric-material foam comprises an operation of carving/cutting a large solid compact block of polymeric-material foam to obtain a piece of the desired shape.

16. Production method as claimed in claim 14, wherein creation of the solid compact block of polymeric-material foam comprises an operation of injecting a given quantity of polymeric-material foam into a mould which reproduces in negative the shape of the block of polymeric-material foam to be produced, and then an operation of extracting from the mould the block of polymeric-material foam resulting from solidification of the polymeric-material foam inside the mould.

17. Production method as claimed in claim 14, wherein realizing the protective surface shell on surface of the block of polymeric-material foam comprises an operation of covering at least the surface portion of the block of polymeric-material foam designed to form the concave recess with at least one layer of mineral stone powders and/or grit embedded in a resin matrix.

18. Production method as claimed in claim 17, wherein realizing said at least one layer of mineral stone powders and/or grit embedded in a resin matrix comprises an operation of spray applying at least one layer of resin on the surface of the block of polymeric-material foam; and then an operation of covering said layer of resin with mineral stone powders and/or grit, so that said mineral stone powders and/or grit are incorporated in the layer of resin which is solidifying.

19. Production method as claimed in claim 14, wherein realizing the protective surface shell on the surface of the block of polymeric-material foam comprises an operation of covering at least the surface portion of the block of polymeric-material foam designed to form the concave recess with an outer layer based on powders of gypsum and/or plaster and/or cement and/or other construction covering material embedded in a resin matrix.

20. Production method as claimed in claim 14, wherein the block of polymeric-material foam is made of a polymeric-material foam having a density higher than 15 kg/m3 (kilograms per cubic meter).

21. Production method as claimed in claim 14, wherein the protective surface shell has a thickness of less than 3 millimeters.
